(19) United States
(12) Patent Application Publication
(10) Pub. No.: US 2025/0080443 A1
(43) Pub. Date: Mar. 6, 2025

(54) MANAGEMENT SYSTEM FOR NETWORK COMMUNICATION DEVICES, MANAGEMENT METHOD FOR NETWORK COMMUNICATION DEVICES, AND NON-TRANSITORY COMPUTER READABLE STORAGE MEDIUM

(71) Applicant: YAMAHA CORPORATION, Hamamatsu-shi (JP)

(72) Inventors: Hidetaka TSURUGA, Hamamatsu-shi (JP); Kosuke ONOYAMA, Hamamatsu-shi (JP)

(21) Appl. No.: 18/808,232

(22) Filed: Aug. 19, 2024

(30) Foreign Application Priority Data
Sep. 4, 2023 (JP) 2023-143181

(51) Int. Cl. H04L 43/091; H04L 43/16

(52) U.S. Cl. CPC H04L 43/091; H04L 43/16

(57) ABSTRACT

A management method for network communication devices is a management method for network communication devices including at least one physical port, the method including acquiring usage state information including a communication state and a power supply state to other communication devices connected to the at least one physical port, and generating a power consumption estimate value based on the usage state information. In the management method for network communication devices, the power consumption estimate value may be generated using qualitative data corresponding to the communication state and quantitative data corresponding to the power supply state among the usage state information.

### CROSS-REFERENCE TO RELATED APPLICATIONS

This application claims the benefit of priority to Japanese Patent Application No. 2023-143181, filed on Sep. 4, 2023, the entire contents of which are incorporated herein by reference.

### FIELD

The present disclosure relates to a management system for network communication devices, a management method for network communication devices, and a non-transitory computer readable storage medium.

### BACKGROUND

In communication in a communication network such as the Internet or a LAN (local area network), network communication devices (router, switching hub) are used. Japanese Laid-Open Patent Publication No. 2001-320415 discloses power saving by controlling power in accordance with a state of access to network communication devices.

### SUMMARY

According to an embodiment of the present disclosure, a management method for network communication devices including at least one physical port is provided, the method including acquiring usage state information including a communication state and a power supply state to other communication devices connected to the at least one physical port by a computer, and generating a power consumption estimate value based on the usage state information by the computer.

In a management method for network communication devices according to an embodiment of the present disclosure, the power consumption estimate value may be generated based on qualitative data corresponding to the communication state and quantitative data corresponding to the power supply state among the usage state information.

In a management method for network communication devices according to an embodiment of the present disclosure, the power consumption estimate value may be generated using a data table showing a relationship between the communication state and power consumption of the network communication devices among the usage state information.

In a management method for network communication devices according to an embodiment of the present disclosure, the method may include storing the power consumption estimate value in a storage device and transmitting to an external device historical information calculated by combining the power consumption estimate value and a power consumption estimate value stored in advance in the storage device.

In a management method for network communication devices according to an embodiment of the present disclosure, the computer may be a network communication device, and the network communication device may store usage state information in a storage device, the network communication device may transmit the usage state information to an external device, and the external device may generate the power consumption estimate value based on the usage state information.

In a management method for network communication devices according to an embodiment of the present disclosure, the method may include obtaining standby state information indicating a standby state of the network communication devices and generating the power consumption estimate value based on the usage state information and the standby state information.

In a management method for network communication devices according to an embodiment of the present disclosure, the power consumption estimate value may be generated based on conversion information indicating a relationship between the usage state information and the standby state information, and power consumption of the network communication devices.

In a management method for network communication devices according to an embodiment of the present disclosure, the method may include updating the conversion information based on a predetermined condition.

In a management method for network communication devices according to an embodiment of the present disclosure, the at least one physical port may include a first physical port and a second physical port different from the first physical port, and the power consumption estimate value may be generated using a first data table showing a relationship between a communication state in the first physical port and power consumption of the network communication devices, and a second data table showing a relationship between a communication state in the second physical port and power consumption of the network communication devices.

In a management method for network communication devices according to an embodiment of the present disclosure, the method may include transmitting the power consumption estimate value to the external device and alerting the power consumption estimate value on the external device.

In a management method for network communication devices according to an embodiment of the present disclosure, alerting the power consumption estimate value may include displaying the power consumption estimate value.

In a management method for network communication devices according to an embodiment of the present disclosure, the network communication devices may be switching hub devices.

According to an embodiment of the present disclosure, a non-transitory computer readable storage medium storing a program for causing a computer to execute the management method for network communication devices is provided.

According to an embodiment of the present disclosure, a management system for network communication devices including at least one physical port is provided, the management system including a processor and a memory configured to store a program, the program executed by the processor to cause the processor to acquire usage state information including a communication state and a power supply state to other communication devices connected to the at least one physical port and generate a power consumption estimate value based on the usage state information.

In the management system for network communication devices according to an embodiment of the present disclosure, the program may cause the processor to generate the power consumption estimate value based on qualitative data corresponding to the communication state and quantitative data corresponding to the power supply state among the usage state information.

In the management system for network communication devices according to an embodiment of the present disclosure, the program may cause the processor to generate the power consumption estimate value using a data table showing a relationship between the communication state and power consumption of the network communication devices among the usage state information.

In the management system for network communication devices according to an embodiment of the present disclosure, the program may cause the processor to store the power consumption estimate value in a storage device and transmit to an external device historical information calculated by combining the power consumption estimate value and a power consumption estimate value stored in advance in the storage device.

In the management system for network communication devices according to an embodiment of the present disclosure, the processor may be a first processor of the network communication devices, a first processor of the network communication devices may store the usage state information in a storage device, a first processor of the network communication devices may transmit the usage state information to an external device, and a second processor of the external device may generate the power consumption estimate value based on the usage state information.

In the management system for network communication devices according to an embodiment of the present disclosure, the program may cause the processor to obtain standby state information indicating a standby state of the network communication devices and generate the power consumption estimate value based on the usage state information and the standby state information.

In the management system for network communication devices according to an embodiment of the present disclosure, the program may cause the processor to generate the power consumption estimate value based on conversion information indicating a relationship between the usage state information and standby state information and power consumption of the network communication devices.

In the management system for network communication devices according to an embodiment of the present disclosure, the program may cause the processor to update the conversion information based on a predetermined condition.

In the management system for network communication devices according to an embodiment of the present disclosure, the at least one physical port may include a first physical port and a second physical port different from the first physical port, and the program may cause the processor to generate the power consumption estimate value using a first data table showing a relationship between a communication state in the first physical port and power consumption of the network communication devices, and the second data table showing a relationship between a communication state in the second physical port and power consumption of the network communication devices.

In a management system for the network communication devices according to an embodiment of the present disclosure, the program may cause the processor to instruct the external device to transmit the power consumption estimate value and to alert the power consumption estimate value.

In a management system for the network communication devices according to an embodiment of the present disclosure, alerting the power consumption estimate value may include displaying the power consumption estimate value.

In a management system for the network communication devices according to an embodiment of the present disclosure, the network communication devices may be switching hub devices.

According to the present disclosure, it is possible to easily realize power consumption of network communication devices.

### BRIEF DESCRIPTION OF DRAWINGS

FIG. 1 is a schematic diagram showing an overall configuration of a communication management system according to an embodiment of the present disclosure.

FIG. 2 is a functional block diagram of a communication management system according to an embodiment of the present disclosure.

FIG. 3 is an example of a data table relating a LAN port and specification information according to an embodiment of the present disclosure.

FIG. 4 is an example of a data table correlating a communication speed and power consumption according to an embodiment of the present disclosure.

FIG. 5 is an example of a data table correlating a communication speed and power consumption according to an embodiment of the present disclosure.

FIG. 6 is an example of a data table correlating a communication speed and power consumption according to an embodiment of the present disclosure.

FIG. 7 is a flowchart showing an example of a flow of processing executed by a communication management system according to an embodiment of the present disclosure.

FIG. 8 is a schematic diagram showing an overall configuration of a communication management system according to an embodiment of the present disclosure.

FIG. 9 is a flowchart showing an example of a flow of processing executed by a communication management system according to an embodiment of the present disclosure.

### DESCRIPTION OF EMBODIMENTS

Hereinafter, embodiments of the present disclosure will be described with reference to the drawings and the like. However, the present disclosure can be implemented in many different aspects, and should not be construed as being limited to the description of the embodiments exemplified below. The drawings may be schematically represented for clarity of explanation, but are merely examples and are not intended to limit the interpretation of the present disclosure. Further, the terms “first” and “second” for each element are convenience labels used to distinguish each element, and do not have any further meaning unless otherwise described. In the drawings referred to in the present embodiment, the same or similar parts are denoted by the same reference signs or similar reference signs (reference signs only denoted by A, B or 1, 2, or the like after the number XXX), and repeated explanation thereof may be omitted. Further, a part of the configuration may be omitted from the drawings. In addition, no particular explanation shall be given with regards to configurations or components if the person ordinarily knowledgeable in the field to which the present disclosure belongs can recognize such configurations or components.

In order to achieve further power saving in a network communication device, it is necessary to accurately grasp the power consumption of the network communication device (for example, a Layer 2 switching hub). At present, although power consumption based on a power supply state can be grasped to some extent, actual power consumption including other states other than the power supply state cannot be grasped.

In view of such problems, the present disclosure discloses a method for easily realizing the power consumption of a network communication device.

### First Embodiment

A communication management system according to a first embodiment of the present disclosure will be described in detail with reference to the drawings.

### [1-1. Configuration of Communication Management System]

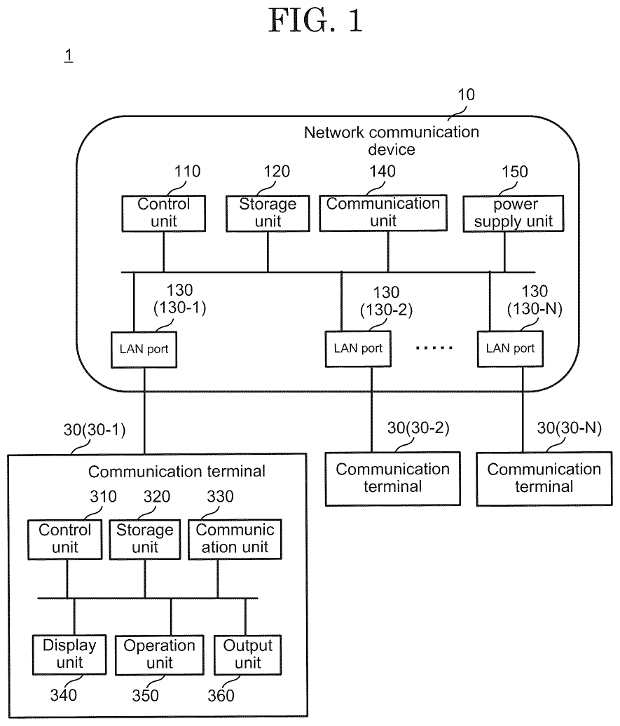

FIG. 1 is a block diagram showing a configuration of a communication management system 1. As shown in FIG. 1, the communication management system 1 includes a network communication device 10 and a communication terminal 30.

### [1-1-1. Network Communication Device 10]

As shown in FIG. 1, the network communication device 10 includes a control unit 110 (also referred to as a first control unit or a first control device), a storage unit 120, a LAN port 130, a communication unit 140, and a power supply unit 150. The control unit 110, the storage unit 120, the LAN port 130, the communication unit 140, and the power supply unit 150 are connected via a wiring bus. In the present embodiment, a switching hub device is used as the network communication device 10. In this case, an L2 (Layer 2) switching hub device is used.

The control unit 110 includes a CPU (Central Processing Unit), ASIC (Application Specific Integrated Circuit), FPGA (Field Programmable Gate Array), or other arithmetic processing circuits, and memories including ROM (Read Only Memory) and RAM (Random Access Memory). The control unit 110 controls functions of the respective units using a communication management program included in the memory.

In addition to a semiconductor memory such as an SSD (Solid State Drive), a magnetic recording medium (magnetic tape, magnetic disk, or the like), an optical recording medium, a magneto-optical recording medium, or a storage device (element) that can store information as a storage medium are used as the storage unit 120 (also referred to as a storage device). The storage unit 120 has a function as a database for storing various types of information used in the communication management program.

The LAN port 130 is a physical port. The LAN port 130 is connected to the communication terminal 30 based on a control of the control unit 110, and is an interface for transmitting and receiving information. A plurality of LAN ports 130 (in this example, LAN ports 130-1, 130-2, . . . , 130-N) are included. In this example, the LAN ports 130 include a LAN port of low-speed communication and a low-power-consumption type that maximizes the communication speed of 2.5 Gbps, a LAN port of a high-speed communication type that maximizes the communication speed of 10 Gbps, and an SFP (Small Form-factor Pluggable). At least one LAN port of each type may be included. In addition, at least one type of LAN port among various types of LAN ports may be included. In addition, in the case where there is no need to distinguish between the various types of LAN ports in the present embodiment, the LAN ports will be described as the LAN port 130.

The communication unit 140 is an interface for transmitting and receiving information to and from another network communication device via a network such as the Internet based on the control of the control unit 110. The communication unit 140 may include a MAC (Media Access Controller) and a communication port.

The power supply unit 150 supplies power to the communication terminal 30. In this situation, the power supply unit 150 performs POE (Power over Ethernet) power supply to the communication terminal 30 via a LAN cable.

### [1-1-2. Communication Terminal 30]

The communication terminal 30 is a computer device (communication device) connected to the network communication device 10. A plurality of communication terminals 30 are arranged according to the LAN ports 130 (in this case, communication terminals 30-1, 30-2, . . . , 30-N are arranged). For example, a personal computer is used as the communication terminal 30. In addition, the communication terminal 30 is not limited to a personal computer, and may be a mobile phone (feature phone), a smart phone, a tablet-type terminal, an IoT (Internet of Things) device (a device including a power supply mechanism, a communication function, and an information storage mechanism), an access point, or the like, and may be any device as long as the device can be connected by wire through the LAN port 130, and can communicate with the respective devices. In the case where the communication terminal 30 is an access point, further different communication terminals may be wirelessly connected to the access point.

The communication terminal 30 may include a control unit 310, a storage unit 320, a communication unit 330, a display unit 340, an operation unit 350, and an output unit 360. The control unit 310 and the storage unit 320 may use devices similar to those of the network communication device 10. The communication unit 330 is an interface for transmitting and receiving information by connecting to the network communication device 10 by wire under the control of the control unit 310. The communication unit 330 may have a configuration similar to that of the LAN port 130. The display unit 340 displays information under a control of the control unit 310 such as a liquid crystal display or an organic EL display. The operation unit 350 is a device that can be operated by a user, such as a button, a keyboard, and a switch. Further, in the present embodiment, the operation unit 350 and the display unit 340 may be arranged so as to overlap each other as in the case of a touch panel. The output unit 360 is a device that outputs information that can be recognized from the outside, such as sound (buzzer), light (LED light), and vibration (vibrator).

### [1-2. Functional Block Diagram of Communication Management System]

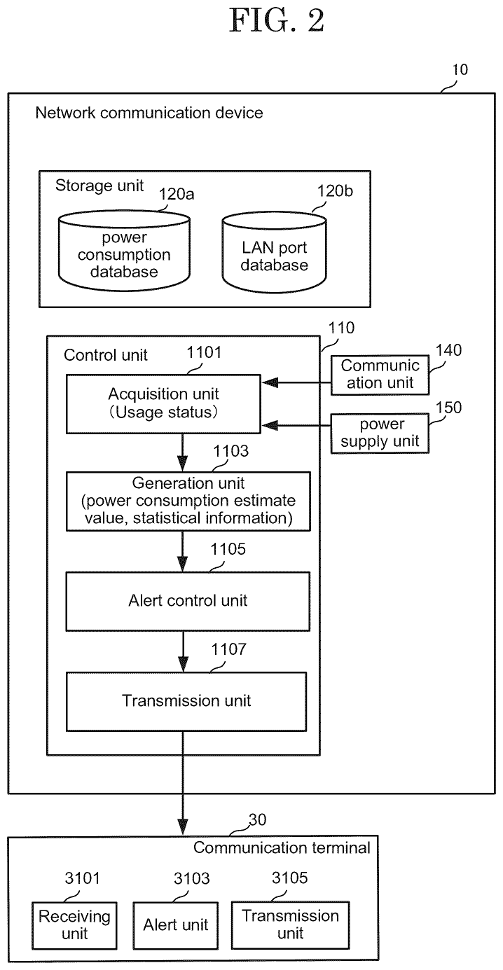

FIG. 2 is a block diagram showing an example of a functional configuration of the communication management system 1. Each function described below is realized by hardware, software, or a combination of hardware and software.

In FIG. 2, the control unit 110 of the network communication device 10 includes an acquisition unit 1101, a generation unit 1103, an alert control unit 1105, and a transmission unit 1107.

The acquisition unit 1101 has a function of acquiring various types of information from the communication terminal 30 and other external devices. In this example, when the communication terminal 30 is connected to the LAN port 130, the acquisition unit 1101 acquires information about a usage state of the network communication device 10 (referred to as “usage state information”). In this example, the usage state information includes a communication state and a power supply state. The communication state indicates a state in which the network communication device 10 and the communication terminal 30 communicate with each other. The power supply state indicates a state in which power is supplied from the network communication device 10 to the communication terminal 30.

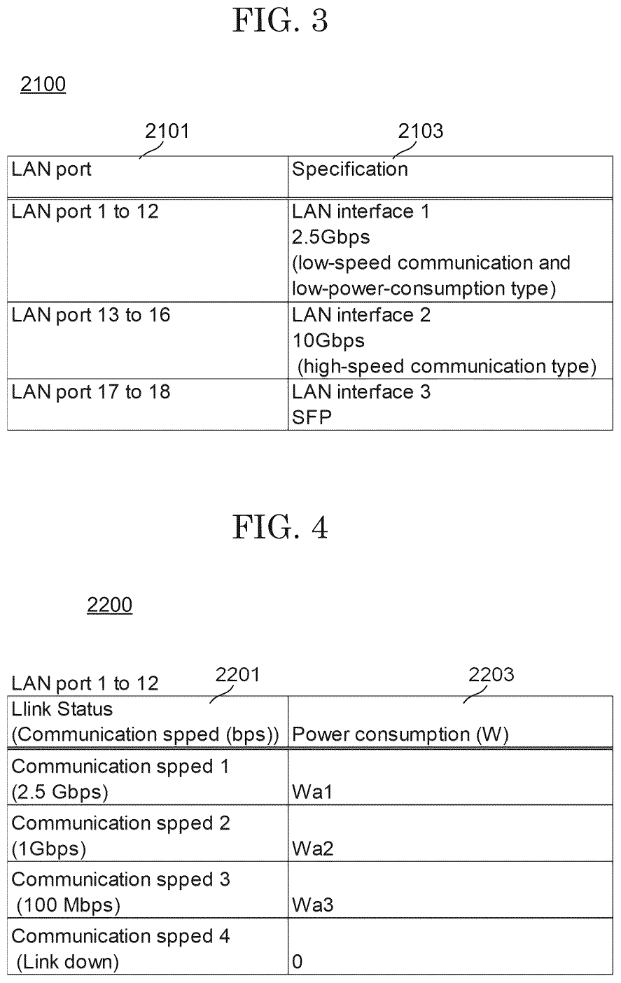

FIG. 3 is a data table 2100 set for each of the LAN ports. The data table 2100 includes LAN port information 2101 and specification information 2103. The data table 2100 associates a relationship between the LAN port information 2101 and the specification information 2103. In this example, the LAN ports 130 have 18 ports. The ports 1 to 12 of the LAN ports 130 correspond to LAN interfaces 1. The ports 1 to 12 are LAN ports of low-speed communication and low-power-consumption types. The ports 13 to 16 correspond to LAN interfaces 2. The ports 13 to 16 are LAN ports of high-speed communication types. The ports 17 to 18 correspond to LAN interfaces 3. The ports 17 to 18 are SFP ports. The data table 2100 may be stored in a LAN port database 120b in the storage unit 120.

The generation unit 1103 has a function of generating various types of information. In an embodiment of the present disclosure, the generation unit 1103 generates a power consumption estimate value. Further, the generation unit 1103 may generate statistical information using a plurality of power consumption estimate values. The generated power consumption estimate values and statistical information are stored in the storage unit 120.

FIG. 4 is a data table 2200 showing a relationship between a communication rate (communication status) of the LAN ports (ports 1 to 12) of the low-speed communication and low-power consumption types among the LAN ports 130 and the power consumption. The data table 2200 includes communication speed information 2201 and power consumption information 2203. The power consumption in the communication state of each of the ports can be calculated from the data table 2200. Since the communication speed information 2201 is information representing a communication state (property), the communication speed information 2201 can be said to be qualitative data. The data table 2200 may be stored in a power consumption database 120a in the storage unit 120.

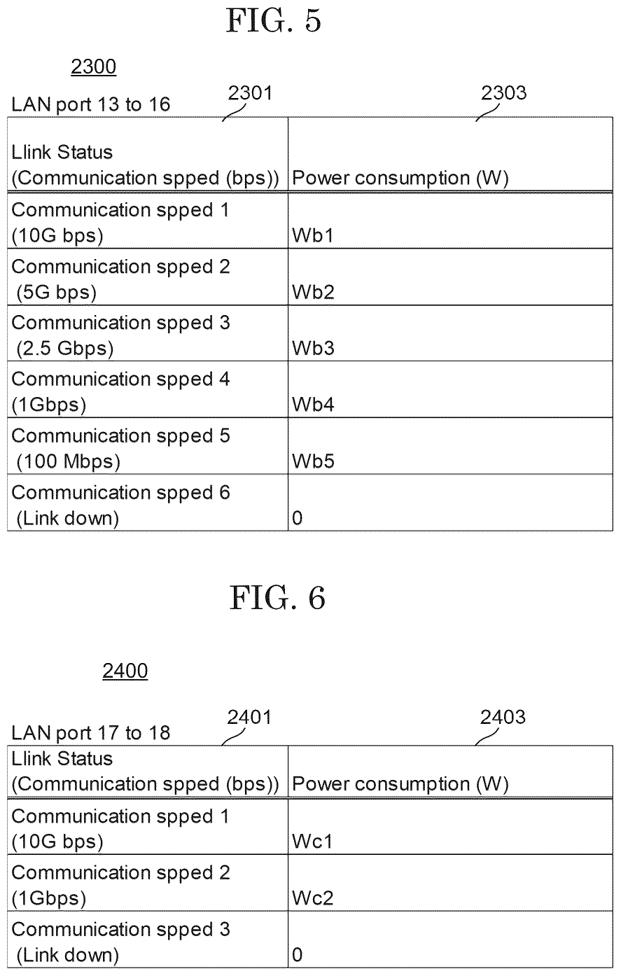

FIG. 5 is a data table 2300 showing a relationship between a communication rate (communication status) of the LAN ports (ports 13 to 16) of high-speed communication types among LAN ports 130 and power consumption. The data table 2300 includes communication speed information 2301 and power consumption information 2303. Similar to the communication speed information 2201, since the communication speed information 2301 is information indicating a communication state, the communication speed information 2301 can be said to be qualitative data. The power consumption in the communication state of each of the ports can be calculated from the data table 2300. The data table 2300 may be stored in the power consumption database 120a in the storage unit 120.

FIG. 6 is a data table 2400 showing a relationship between a communication rate (communication status) of the LAN ports (ports 17 to 18) of SFP types among the LAN ports 130 and power consumption. The data table 2400 includes communication speed information 2401 and power consumption information 2403. Similar to the communication speed information 2201, since the communication speed information 2401 is information indicating a communication state, it can be said to be qualitative data. The power consumption in the communication state of each of the ports can be calculated from the data table 2400. The data table 2400 may be stored in the power consumption database 120a in the storage unit 120.

In the present embodiment, if the type of LAN port is different, power consumption may differ even if the communication speed is the same. Specifically, power consumption Wa1 of 2.5 Gbps in a LAN port A which is a low-speed type LAN port may be less than power consumption Wb3 of 2.5 Gbps of a LAN port B which is a high-speed type LAN port.

The alert control unit 1105 has a controlling function so as to alert the power consumption estimate value. The transmission unit 1107 has a function of transmitting various kinds of information to another device (external device) such as the communication terminal 30.

The communication terminal 30 includes a receiving unit 3101, an alert unit 3103, and a transmission unit 3105. The receiving unit 3101 has a function of receiving a frame signal, an alert signal, and various signals from the network communication device 10. The alert unit 3103 has a function of alerting from the display unit 340 or the output unit 360 based on the received alert instruction signal. The transmission unit 3105 has a function of transmitting various types of information to the network communication device 10.

### [1-3. Communication Management Process]

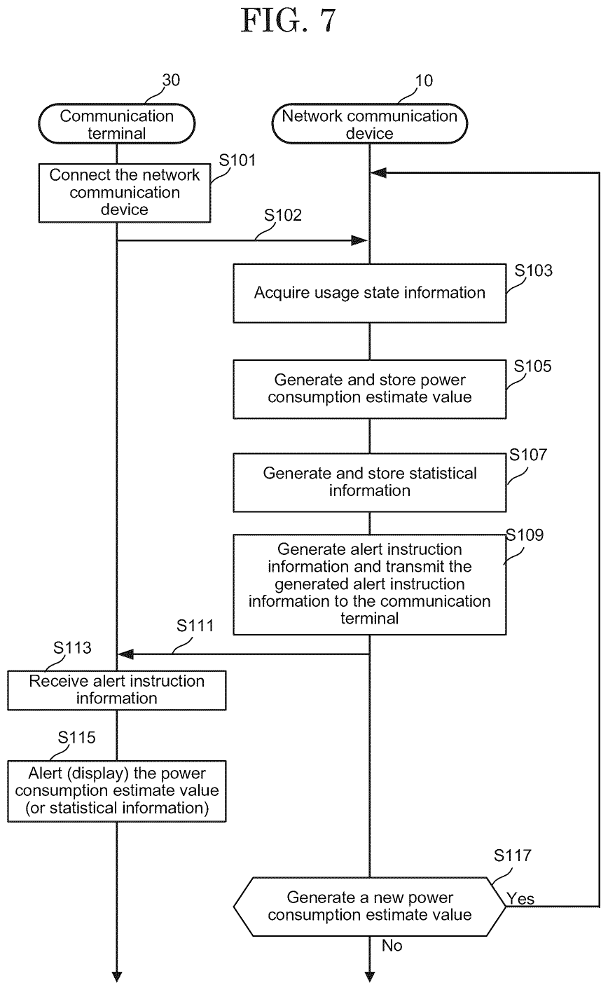

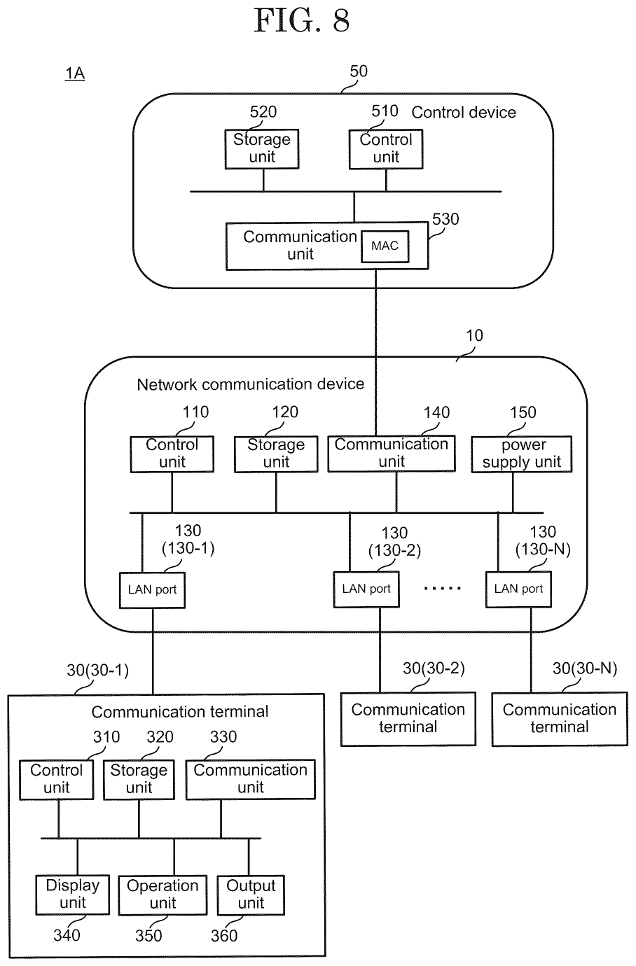

Next, a communication management process based on a command by the communication management program will be described with reference to FIG. 7.

As shown in FIG. 7, first, the communication terminal 30 is connected to the network communication device 10 (step S101). In this case, various types of request information such as communication request information and power supply request information are transmitted from the communication terminal 30 to the network communication device 10 (step S102). The network communication device 10 acquires usage state information based on the request information (step S103). Further, the network communication device 10 grasps which LAN port of the plurality of LAN ports 130 the communication terminal 30 was connected to. As a result, it is possible to grasp the type of LAN port. Further, the network communication device 10 grasps whether the communication terminal 30 is in a communication state or a power supply state according to the usage state information. The usage state information may also be referred to as “raw data” for generating a power consumption estimate value.

Next, the network communication device 10 generates a power consumption estimate value based on the obtained usage state information (step S105). In this example, when generating the power consumption estimate value PALL, the equation 1 below is used.

$${P}_{ALL} = {P}_{LINK} + {P}_{PoE} \qquad ( Equation 1 )$$

The network communication device 10 calculates power P_{LINK} consumed by communication at the respective ports using the equation 2 below.

$${P}_{LINK} = {\sum }_{n = MIN}^{MAX} {P}_{2.5 G} ( LINK\_STATUS ( n ) ) + {\sum }_{n = MIN}^{MAX} {P}_{10 G} ( LINK\_STATUS ( n ) ) + {\sum }_{n = MIN}^{MAX} {P}_{SFP} ( LINK\_STATUS ( n ) ) \qquad ( Equation 2 )$$

In the equation 2, P_{2.5G} (LINK_STATUS(n)) indicates power consumption for communication in the ports 1 to 12 of the LAN ports 130. P_{10G} (LINK_STATUS(n)) indicates power consumption for communication in the ports 13 to 16 of the LAN ports 130. P_{SFP} (LINK_STATUS(n)) indicates power consumption for communication in the ports 17 to 18 of the LAN ports 130.

When calculating P_{LINK}, the data table 2200 shown in FIG. 4, the data table 2300 shown in FIG. 5, and the data table 2400 shown in FIG. 6 are used. As shown in FIG. 4 to FIG. 6, the power consumption varies depending on the communication speed. That is, it can be said that the power consumption data corresponding to the communication state is data based on qualitative data such as the communication state.

The network communication device 10 calculates power consumed in a power supply state of each of the ports by using the equation 3 below.

$${P}_{PoE} = {\sum }_{n = MIN}^{MAX} {P}_{n} \qquad ( Equation 3 )$$

Pₙ is power consumed by power supply at each port.

As shown in the equation 3, in an embodiment of the present disclosure, power consumption in a power supply state may be common to each port. In this case, the power consumption increases according to the number of communication terminals to which power is supplied. Therefore, it can be said that power consumption data corresponding to the power supply state is quantitative data. In the present embodiment, electric conversion efficiency in the power supply unit (power supply unit 150) of the network communication device 10 with respect to an amount of power supplied from each of the LAN ports 130 is constant. In addition, the electric conversion efficiency may be maximized at a position of about ½ of a maximum power consumption, and the efficiency may decrease moving away from this position.

Based on the above description, it can be said that the power consumption estimate value is generated using qualitative data and quantitative data.

The network communication device 10 stores the generated power consumption estimate value in the power consumption database 120a of the storage unit 120. Next, the network communication device 10 generates statistical information using the generated power consumption estimate values (step S107). The statistical information may be historical information combined with a pre-generated power consumption estimate value. The statistical information may be generated every predetermined period (time, day, or month). The statistical information may be, for example, an average value or a median value. The statistical information may be character data or a graph. The network communication device 10 stores the generated statistical data in the power consumption database 120a of the storage unit 120.

Next, the network communication device 10 generates alert instruction information for alerting the generated power consumption estimate value or the statistical information (step S109) to the communication terminal 30. Next, the network communication device 10 transmits the generated alert instruction information to the communication terminal 30 (step S109).

When receiving the alert instruction information (step S113), the communication terminal 30 alerts the power consumption estimate value (or statistical information (step S115). In this example, the communication terminal 30 displays the power consumption estimate value (or statistical information) on the display unit 340.

After the alert instruction is generated, the network communication device 10 determines whether to generate a new power consumption estimate value (step S117). In this case, the determination may be made based on information transmitted from the communication terminal 30 input by the user. If a new power consumption estimate value is to be generated (step S117; Yes), the process returns to the step S101 again. If no new power consumption estimate value is generated (step S117; No), the communication managing process ends.

It is possible to estimate power consumption estimation from a usage state without newly using a device, a chip, a circuit, or the like by using the present embodiment. Therefore, it is possible to easily grasp the power consumption of the network communication device by using the present embodiment.

### Second Embodiment

In the present embodiment, a communication management system different from the first embodiment will be described in detail with reference to the drawings. Specifically, an example in which a power consumption estimate value is generated by a device different from the network communication device 10 will be described. Configurations similar to those of the first embodiment will be omitted as appropriate for the sake of explanation.

### [2-1. Configuration of Communication Management System 1A]

FIG. 8 is a block diagram showing a configuration of a communication management system 1A. As shown in FIG. 8, the communication managing system 1A includes an external device (in this embodiment, a control device 50) arranged outside the network communication device 10, in addition to the network communication device 10 and the communication terminal 30.

The control device 50 includes a control unit 510, a storage unit 520, and a communication unit 530. A device similar to the network communication device 10 and the communication terminal 30 may be used for the control unit 510, the storage unit 520, and the communication unit 530.

In the present embodiment, when usage state information is acquired, the network communication device 10 may store the usage state information in the storage unit 120. The network communication device 10 may transmit the usage state information to the control device 50. The control unit 510 (also referred to as a second control unit or a second control device) of the control device 50 may generate a power consumption estimate value based on the received usage state information. That is, power consumption may be grasped by the external device using the acquired usage state information.

### Third Embodiment

In the present embodiment, a communication management process different from the first embodiment will be described. Specifically, an example in which a power consumption estimate value is generated based on a standby state in addition to a usage state will be described. Configurations similar to those of the first embodiment will be omitted as appropriate for the sake of explanation.

In the present embodiment, the acquisition unit 1101 of the control unit 110 acquires standby state information indicating a standby state. The generation unit 1103 may generate a power consumption estimate value using the equation 4 below.

$${P}_{ALL} = {P}_{0} + {P}_{LINK} + {P}_{PoE} \qquad ( Equation 4 )$$

P₀ is power consumed in the standby state and is constant. P₀ is power consumed regardless of whether or not the communication terminal 30 is connected to the network communication device.

Further, in the present embodiment, the network communication device 10 may calculate the power consumed in a power supply state of each port by using the equation 5 below.

$${P}_{PoE} = WEIGHT\_PoE \times {\sum }_{n = MIN}^{MAX} {P}_{n} \qquad ( Equation 5 )$$

WEIGHT_PoE corresponds to a weight factor of the power supply state. In this example, power efficiency may be evaluated by measuring a design sample. Based on the results of this evaluation, a WEIGHT_PoE value may be determined. The determined WEIGHT_PoE value may be stored in the memory in advance. A new WEIGHT_PoE value may be received from the Internet (e.g., from a dedicated server, etc.). The WEIGHT_PoE value may be directly obtained using a USB memory stick or other storage device. The WEIGHT_PoE value used in Equation 5 may be updated based on the acquired WEIGHT_PoE value.

In the present embodiment, P₀ and WEIGHT_PoE can be referred to as conversion information indicating a relationship between usage state information and standby state information and power consumption in the network communication device 10. The conversion information may include the data tables 2200 to 2400 described in the first embodiment. In the present embodiment, a power consumption estimate value is generated by using the conversion information, so that the power consumption can be grasped in more detail.

Further, in the present embodiment, the conversion information may be updated based on a predetermined condition. For example, the conversion information may be updated at a timing at which update request information is transmitted from the communication terminal 30, or may be updated after a certain period of time has elapsed, or may be updated for a specific period of time and then returned to an initial value. This makes it possible to grasp the power consumption corresponding to a state of the device, such as an operation period of a product.

### Fourth Embodiment

In the present embodiment, a communication management process different from the first embodiment will be described. Specifically, an example of providing a warning when a power consumption estimate value satisfies a predetermined condition will be described. Configurations similar to those of the other embodiments will be omitted as appropriate for the sake of explanation.

In the present embodiment, the alert control unit 1105 may control so as to alert when a power consumption estimate value satisfies a predetermined condition. In this example, the predetermined condition is that the power consumption estimate value exceeds a preset threshold value. Data of threshold values may be stored in the power consumption database (power consumption DB) 120a of the storage unit 120.

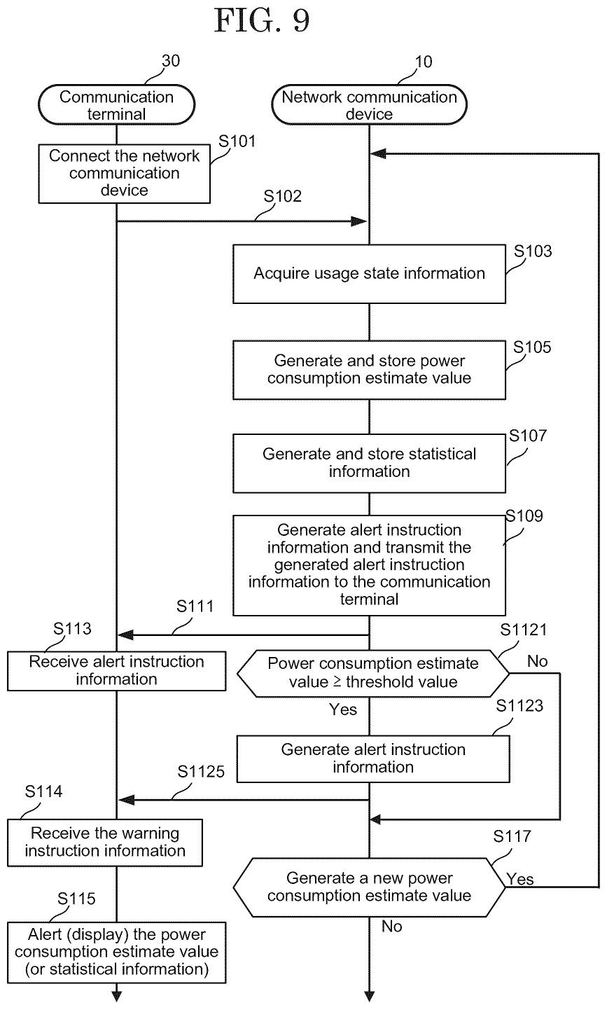

FIG. 9 is a flowchart showing an example of a flow of processing executed by a communication management system according to the present embodiment. In the present embodiment, after the alert instruction information is generated (step S109), it may be determined whether the generated power consumption estimate value (or statistical information) satisfies a predetermined condition (step S1121). In this example, the network communication device 10 may determine whether the power consumption estimate value (or statistical information) is equal to or greater than a preset threshold value. When the power consumption estimate value (or the statistical information) is equal to or larger than the preset threshold value (step S1121; Yes), the network-communication device 10 generates alert instruction information (step S1123). The network communication device 10 transmits the generated alert instruction information to the communication terminal 30 (external device) (step S1125). The communication terminal 30 receives the warning instruction information in addition to the alert instruction information (step S113) (step S114). The communication terminal 30 may alert the power consumption estimate value based on the alert instruction information and the warning instruction information, and may also alert that the power consumption estimate value satisfies a predetermined condition (is equal to or larger than the threshold value) (step S116).

In the present embodiment, it may be determined whether to generate a new power consumption estimate value (step S117) if the power consumption estimate value does not satisfy the predetermined condition (step S1121; No) or after the alert instruction information is generated (step S1123).

In addition to being able to alert the power consumption estimate value, it is possible to alert a user of the communication terminal (or an administrator of the network communication device) to an abnormal state when there is an abnormality such as when there is a large power consumption by using the present embodiment.

In addition, in the present embodiment, although an example has been described in which it is determined whether or not the power consumption estimate value is equal to or larger than the threshold value after the alert instruction information is generated, the present disclosure is not limited to this. In the case where the power consumption estimate value is equal to or larger than the threshold value, an instruction may be given to alert the power consumption estimate value.

### Modification

Within the scope of the idea of the present disclosure, a person skilled in the art can conceive of various modifications and examples, and it is understood that these modifications and examples fall within the scope of the present disclosure. For example, a person skilled in the art appropriately adds, deletes, or changes in design of the constituent elements, or adds, omits, or changes in conditions of the steps with respect to each of the embodiments described above and such changes are included in the scope of the present disclosure as long as the subject matter of the present disclosure is provided.

In an embodiment of the present disclosure, although the L2 switching hub device is used as the network communication device, the present disclosure is not limited thereto. For example, an L3 switching hub device or a router may be used as the network communication device 10.

In addition, in an embodiment of the present disclosure, even if the same type of LAN port is used, a different data table may be used. For example, a different data table can be applied in the case where a chip IC for communication arranged in the LAN port is different. This makes it possible to estimate power consumption more accurately.

Further, in an embodiment of the present disclosure, although an example in which the power consumption in the power supply state is common to each port has been described, the present disclosure is not limited thereto. In the case where high-speed power supply is performed, power consumption in the power supply may be different depending on the type of LAN port.

In an embodiment of the present disclosure, although an example in which the network communication device 10 generates the warning instruction information when the power consumption estimate value (or the statistical information) satisfies a predetermined condition (is a threshold value) has been described, the present disclosure is not limited thereto. For example, in the case where the network communication device 10 includes an output unit, the network communication device 10 may alert that the power consumption estimate value satisfies a predetermined condition via the output unit itself.

In an embodiment of the present disclosure, although an example in which the network communication device 10 includes a plurality of LAN ports, the present disclosure is not limited thereto. The network communication device 10 may include at least one LAN port.

In addition, although an example in which the power consumption estimate value or the statistical information is transmitted to the communication terminal 30 has been described in the embodiment of the present disclosure, the present disclosure is not limited thereto. The power consumption estimate value or the statistical information may be transmitted to an external device other than the communication terminal 30.

Further, in an embodiment of the present disclosure, although an example has been described in which the warning information is generated when the power consumption estimate value is equal to or larger than the threshold value, the present disclosure is not limited thereto. For example, in the case where the power consumption estimate value becomes equal to or larger than the threshold value, a communication speed may be decreased or a power supply amount may be decreased. Specifically, the network communication device 10 generates a power consumption estimate value based on the usage state information obtained from the communication terminal 30. When the generated power consumption estimate value is greater than a preset threshold value (that is, the power consumption estimate value satisfies the predetermined condition), the network communication device 10 may reduce the amount of power supplied from each of the LAN ports 130 or reduce the communication speed at the LAN ports 130. As a result, an increase in power consumption can be suppressed and power consumption can be stabilized.

What is claimed is:

1. A management method for a network communication device including at least one physical port, the method comprising:
acquiring usage state information including a communication state and a power supply state between the network communication device and at least one further communication device connected to the at least one physical port; and
generating a power consumption estimate value based on the usage state information.

2. The management method according to claim 1, wherein
the power consumption estimate value is generated based on
qualitative data corresponding to the communication state in which the network communication device and the at least one further communication device communicate with each other, and
quantitative data corresponding to the power supply state in which the network communication device supplies power to the at least one further communication device.

3. The management method according to claim 1, wherein
the power consumption estimate value is generated using a data table including a relationship between the communication state and power consumption of the network communication device.

4. The management method according to claim 1, further comprising:
storing the power consumption estimate value in a storage device;
calculating historical information by combining the power consumption estimate value and a previous power consumption estimate value stored in advance in the storage device; and
transmitting, to an external device or to the at least one further communication device, the historical information.

5. The management method according to claim 1, further comprising:
obtaining standby state information indicating a standby state of the network communication device; and
generating the power consumption estimate value based on the usage state information and the standby state information.

6. The management method according to claim 5, wherein
the power consumption estimate value is generated based on conversion information indicating a relationship between the usage state information and the standby state information, and power consumption of the network communication device.

7. The management method according to claim 6, further comprising:
updating the conversion information based on a predetermined condition.

8. The management method according to claim 1, wherein
the at least one physical port includes a first physical port and a second physical port different from the first physical port, and
the power consumption estimate value is generated using
a first data table including a relationship between a communication state at the first physical port and power consumption of the network communication device, and
a second data table different from the first data table, and including a relationship between a communication state at the second physical port and power consumption of the network communication device.

9. The management method according to claim 1, further comprising:
determining whether the power consumption estimate value satisfies a predetermined condition; and
in response to the power consumption estimate value satisfying the predetermined condition, transmitting, to an external device or to the at least one further communication device, warning instruction information alerting that the power consumption estimate value satisfies the predetermined condition.

10. The management method according to claim 1, further comprising:
determining whether the power consumption estimate value is equal to or larger than a predetermined threshold value; and
in response to the power consumption estimate value being equal to or larger than the predetermined threshold value, decreasing at least one of:
a communication speed between the network communication device and the at least one further communication device, or
a power supply amount supplied from the network communication device to the at least one further communication device.

11. The management method according to claim 1, wherein
the network communication device is a switching hub device.

12. A non-transitory computer readable storage medium storing a program for causing a computer executing the program to perform a management method for a network communication device including at least one physical port, the method comprising:
acquiring usage state information including a communication state and a power supply state between the network communication device and at least one further communication device connected to the at least one physical port; and
generating a power consumption estimate value based on the usage state information.

13. A management system for a network communication device including at least one physical port, the system comprising:
a processor; and
a memory configured to store a program executable by the processor to cause the processor to:
acquire usage state information including a communication state and a power supply state between the network communication device and at least one further communication device connected to the at least one physical port; and
generate a power consumption estimate value based on the usage state information.

14. The management system according to claim 13, wherein
the program causes the processor to generate the power consumption estimate value based on
qualitative data corresponding to the communication state in which the network communication device and the at least one further communication device communicate with each other, and
quantitative data corresponding to the power supply state in which the network communication device supplies power to the at least one further communication device.

15. The management system according to claim 14, wherein
the program causes the processor to:
generate the power consumption estimate value using a data table including a relationship between the communication state and power consumption of the network communication device.

16. The management system according to claim 13, wherein
the program causes the processor to:
store the power consumption estimate value in a storage device;
calculate historical information by combining the power consumption estimate value and a previous power consumption estimate value stored in advance in the storage device; and
transmit, to an external device or to the at least one further communication device, the historical information.

17. The management system according to claim 13, wherein
the program causes the processor to:
obtain standby state information indicating a standby state of the network communication device; and
generate the power consumption estimate value based on the usage state information and the standby state information.

18. The management system according to claim 17, wherein
the program causes the processor to:
generate the power consumption estimate value based on conversion information indicating a relationship between the usage state information and the standby state information, and power consumption of the network communication devices.

19. The management system according to claim 18, wherein
the program causes the processor to:
update the conversion information based on a predetermined condition.

20. The management system according to claim 13, wherein
the at least one physical port includes a first physical port and a second physical port different from the first physical port, and
the program causes the processor to generate the power consumption estimate value using
a first data table including a relationship between a communication state at the first physical port and power consumption of the network communication device, and
a second data table different from the first data table, and including a relationship between a communication state at the second physical port and power consumption of the network communication device.
